(19) United States
(12) Patent Application Publication
(10) Pub. No.: US 2009/0312501 A1
(43) Pub. Date: Dec. 17, 2009

(54) PROCESSES FOR PREPARING SILICONE-MODIFIED POLYESTER RESINS

(76) Inventor: Alex Webb, Cary, NC (US)

Correspondence Address: MYERS BIGEL SIBLEY & SAJOVEC, PO BOX 37428, RALEIGH, NC, 27627, US

(21) Appl. No.: 12/137,637

(22) Filed: Jun. 12, 2008

(51) Int. Cl. C08L 67/00

(52) U.S. Cl. 525/444

(57) ABSTRACT

Provided herein are processes for making a silicone-modified polyester resins. According to some embodiments of the invention, processes include reactively extruding a dry mixture including a solid polyester resin and a solid silicone resin.

### FIELD OF THE INVENTION

The present invention relates to methods of preparing polyester resins. More particularly, the present invention relates to methods of preparing silicone-modified polyester resins.

### BACKGROUND OF THE INVENTION

Silicone modified polyester (SMP) resins have many potential industrial uses, including such applications as industrial, architectural and maintenance coatings, and high temperature enamels such as those used bakeware, cookware and automotive parts. In some of the SMP used in such technologies, the SMP resins may further be crosslinked, e.g., via melamines or isocyanate functionalities.

Due to the desirability of low VOC coatings, powder SMP compositions have been investigated. However, when liquid or flake silicones are used to synthesize SMP resins, the SMP particles that result may undesirably agglomerate, which may negatively affect the performance of the SMP resins.

In addition, even when SMP resins are prepared using silicones having a sufficiently high glass transition temperature so as to reduce particle agglomeration, it may be difficult to produce uniform and reproducible SMP, particularly when large scale processing is desired. Specifically, the SMP generally is held at an elevated temperature to maintain the SMP in a molten state during unloading from batch processing. During the relatively long holding times, the SMP may continue to react such that a disadvantageously viscous, non-uniform and/or irreproducible SMP resin may result.

Therefore, a method for producing SMP resins having desirable viscosity, uniformity and/or reproducibility, and a method for producing desirably stable SMP particles, is needed.

### SUMMARY OF THE INVENTION

According to some embodiments of the present invention, provided are processes for making a silicone-modified polyester resin. Such processes include reactively extruding a dry mixture that includes a solid polyester resin and a solid silicone resin.

In some embodiments of the invention, the dry mixture of the solid polyester resin and the solid silicone resin is reactively extruded in screw-feed barrel extruder.

In some embodiments of the invention, the maximum temperature of the reactive extrusion is less than about 180° C. In some embodiments, the maximum temperature of the reactive extrusion is less than about 170° C. Additionally, in some embodiments, the dry mixture is reactively extruded for less than about 2 minutes.

In some embodiments of the invention, the solid silicone resin has a glass transition temperature of greater than about 50° C. In some embodiments, the solid silicone resin has a glass transition temperature in a range of about 57° C. to about 64° C. In some embodiments, the solid polyester resin has a glass transition temperature of greater than about 45° C. In some embodiments, the solid polyester resin has a glass transition temperature in a range of about 52° C. to about 60° C.

In some embodiments of the invention, processes include reactively extruding a dry mixture including a solid polyester resin and a solid silicone resin, wherein the solid silicone resin is present in the dry mixture at a concentration in a range of about 30 weight percent to about 60 weight percent, and wherein the sum of the weight percent of the solid polyester resin and the solid silicone resin equals 100 weight percent.

According to some embodiments of the invention, the processes include reactively extruding a dry mixture including a solid polyester resin and a solid silicone resin, wherein the solid polyester resin is present in the dry mixture at a concentration in a range of about 40 weight percent to about 70 weight percent, and wherein the sum of the weight percent of the solid polyester resin and the solid silicone resin equals 100 weight percent.

In some embodiments of the invention, the solid polyester resin includes a catalyst, such as a dibutyltin and/or phosphite-based catalyst.

In some embodiments of the invention, the solid silicone resin includes less than 20 percent difunctional silicone units. In some embodiments, the solid silicone resin includes greater than about 80 weight percent tri- and quadra-functional silicon oxide units and less than about 6 weight percent silanol/alkoxy functional silicon oxide units.

In some embodiments, the solid polyester resin has a phenol content of greater than about 30 weight percent. In some embodiments, the solid polyester resin includes a hydroxylated polyester having an OH content of greater than about 40 and an acid value of less than about 10.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Provided herein are processes for making a silicone-modified polyester resins. According to some embodiments of the invention, processes include reactively extruding a dry mixture including a solid polyester resin and a solid silicone resin.

The term “solid polyester resin” refers to a polyester resin which has a glass transition temperature (T_{g}) of greater than about 30° C., as measured by differential scanning calorimetry (DSC). In some embodiments, the solid polyester resin has a T_{g} of greater than 45° C., and in some embodiments, the solid polyester resin has a T_{g} in a range of 52° C. to 60° C. Suitable polyester resins will be known to those of skill in the art. In particular embodiments, the solid polyester resin is a hydroxylated polyester having an OH value from about 40 to about 360, and in some embodiments, the solid polyester resin has an acid value less than about 10. Exemplary polyester resins include those described in col. 3, line 47 through col. 5. line 9, of U.S. Pat. No. 7,129,310, this portion of which is incorporated herein by reference in its entirety. Additional exemplary polyester resins include those described in col. 3, line 12, through col. 4, line 22, of U.S. Pat. No. 5,780,195, this portion of which is incorporated by reference in its entirety. In some embodiments, the polyester resins include a hydroxylated polyester resin. Exemplary hydroxylated polyester resins include Fine-Clad® M-8023, M-8025, M-8076, M-8078. Glycidyl methacrylate acrylic resins, such as Fine-Clad® A-241, A-253, A-254 A-257, A-270, A-272, may also be used in combination with or in place of the solid polyester resin.

The term “solid silicone resin” refers to a silicone resin which has a T_{g} of greater than about 30° C., as measured by DSC. In some embodiments, the silicone resin has a T_{g} of about 50° C., and in some embodiments, the silicone resin has a T_{g} in a range of about 57° C. to about 64° C. Suitable solid silicone resins will be apparent to those of skill in the art. In some embodiments, the solid silicone resin includes greater than 80 weight % of tri- (SiRO₃) and quadra-functional (SiO₄) silicon oxide units. As such, in some embodiments, the solid silicone resin includes less than 20 weight % difunctional (SiR₂O₂) silicon oxide units. In particular embodiments, the solid silicone resin has a phenol content of greater than about 30 weight percent. Exemplary solid silicone resins include those described col. 5, lines 10 through 60, of U.S. Pat. No. 7,129,310, this portion of which is incorporated by reference herein in its entirety. In addition, in particular embodiments, the solid silicone resin includes Silres® SY-530, manufactured by Wacker-Chemie GmbH. Exemplary solid silicone resins include Silres® SY-231, Silres® SY-300 and Silres-SY-409.

In some embodiments, the solid polyester resin and/or the solid silicone resin may include a catalyst. For example, in some embodiments, the catalyst may include a dibutyltin type catalyst and/or a phosphite-based catalyst.

The term “reactively extruding” refers to extruding processes whereby one or more of the components chemically react with another component during the extruding process. For example, in some embodiments, the solid silicone resin and the solid polyester resin react with each other during the extruding process to form a silicone modified polyester resin.

The reactive extrusion may be performed by any suitable method. However, in some embodiments, the dry mixture of solid silicone resin and solid polyester resin may be reactively extruded in a screw feed barrel extruder. In particular embodiments, the extruder may be a twin screw extruder with multiple heating zones, such as a Baker-Perkins® model MP19PC extruder.

Any suitable reaction temperature may be used to reactively extrude the solid silicone resin and the solid polyester resin. Additionally, in particular embodiments, the extruder may have multiple heating zones. In some embodiments, the maximum reaction temperature in the extruder is less than about 180° C., and in some embodiments, less than about 170° C. However, in some embodiments, the maximum extrusion temperature may be in a range of about 150° C. and about 230° C. The solid silicone resin and the solid polyester resin may react for a relatively short period of time, depending on the reaction temperature. In some embodiments, the solid silicone resin and the solid polyester resin are reactively extruded for less than two minutes, and in some embodiments, are reactively extruded for less than one minute.

Any suitable proportion of the solid silicone resin and the solid polyester resin may be present in the dry mixture. However, in some embodiments, the solid silicone resin is present in the dry mixture at a concentration in a range of about 5 to 80 weight percent, and in some embodiment, at a concentration in a range of about 30 weight percent to about 60 weight percent. In some embodiments the solid polyester resin is present in the dry mixture at a concentration in a range of about 20 weight percent to about 95 weight percent, and in some embodiments, at a concentration in a range of about 40 weight percent to about 70 weight percent. The sum of the weight percent of the solid silicone resin and the weight percent of the solid polyester resin is 100.

The SMP may be useful in many applications. For example, the SMP may be used in coating compositions. In some embodiments, coating compositions are formed by mixing the SMP with at least one additional component, such as at least one of a crosslinker, pigment, extender, or other additives and modifiers known to those of skill in the art. Any suitable pigment may be included in such compositions, including pigments used in the manufacturing of powder polyester coatings. Other additives that may be included in compositions, according to some embodiments of the invention, include, but are not limited to, hardeners (e.g., melamine hardeners); degassing agents and leveling agents.

The present invention will now be described in more detail with reference to the following examples. However, these examples are given for the purpose of illustration and are not to be construed as limiting the scope of the invention.

### EXAMPLES

### Example 1

A hydroxylated polyester powder resin formed from trimethylol ethane, tere-phthalic acid and isophthalic acid at a weight ratio of 49/17/34. and with a hydroxyl value of 340 (acid value <10), was premixed with a silicone resin that is solid at room temperature (similar to Wacker Silres® SY-530) in the following proportions:

| | Weight (%) |
|---|---|
| Polyester Powder Resin | 68 |
| Silicone Resin | 32 |

In an alternative procedure, the material can be meter fed directly into the extruder in the same proportions. The mixture was then extruded in a twin-screw extruder with multiple heat zones (Baker-Perkins model MP19PC). The feed rate was ˜3-4 kg/hour (feed rate adjusted to maintain screw torque of 55-60), the screw speed was 400 rpm and both vents were open.

| Zone (from Feed End) | Temperature (° C.) |
|---|---|
| 1 | 36 |
| 2 | 100 |
| 3 | 120 |
| 4 | 140 |
| 5 | 160 |
| 6 | 165 |
| 7 | 165 |
| 8 | 165 |

The resulting material had the following characteristics:
OH Value=221
Acid Value=6
T_{g}=60° C.
Shimadzu T_{1/2}=112° C.

### Example 2

A hydroxylated polyester powder resin formed from glycerine, trimethylol propane, neopentyl glycol, ethylene glycol, isophthalic acid at a weight ratio of 2.1/6.4/28.0/3.2/60.1 and with a hydroxyl value of 80 (acid value <10), was premixed with a silicone resin that is solid at room temperature (similar to Wacker Silres® SY-530) in the following proportions:

| | Weight (%) |
|---|---|
| Polyester Powder Resin | 40 |
| Silicone Resin | 60 |

In an alternative procedure, the material can be meter fed directly into the extruder in time same proportions. The mixture was then extruded in a twin-screw extruder with multiple heat zones (Baker-Perkins model MP19PC). The feed rate was ˜5-6 kg/hour (feed rate adjusted to maintain screw torque of 50-54), the screw speed was 250 rpm and the first vent was closed

| Zone (from Feed End) | Temperature (° C.) |
|---|---|
| 1 | 36 |
| 2 | 100 |
| 3 | 120 |
| 4 | 140 |
| 5 | 160 |
| 6 | 165 |
| 7 | 170 |
| 8 | 175 |

The resulting material had the following characteristics:
OH Value=35
Acid Value=5
T_{g}=57° C.
Shimadzu T_{1/2}=110° C.

### Example 3

Hydroxylated polyester powder resin (Fine-Clad® M-8023 or Fine-Clad® M-8076) with a hydroxyl value of 40 (acid value <10) was premixed with a silicone resin that is solid at room temperature (similar to Wacker Silres® SY-530) in the following proportions:

| | Weight (%) |
|---|---|
| Polyester Powder Resin | 68 |
| Silicone Resin | 32 |

In an alternative procedure, the material can be meter fed directly into the extruder in the same proportions. The mixture was then extruded in a twin-screw extruder with multiple heat zones (Baker-Perkins model MP19PC). The feed rate was ˜4-5 kg/hour (feed rate adjusted to maintain screw torque of 40-45), the screw speed was 400 rpm and both vents were open.

| Zone (from Feed End) | Temperature (° C.) |
|---|---|
| 1 | 36 |
| 2 | 100 |
| 3 | 120 |
| 4 | 140 |
| 5 | 165 |
| 6 | 170 |
| 7 | 175 |
| 8 | 175 |

The resulting material had the following characteristics:
OH Value=27
Acid Value=6
T_{g}=62° C.
Shimadzu T_{1/2}=109° C.

### Example 4

The resin from Example 1 was extruded with melamine hardner, pigment, degassing agent and a leveling agent. Four different compositions were extruded, with the reaction compositions and conditions described in Table 1. After extrusion, panels were sprayed and the coating was cured at 260° C. for 10 minutes.

The resulting resins, PE1, PE2, PE3 and PE4, were then evaluated for hot hardness, film thickness, gloss, visual characterization, cross cut, MEK(dr), impact, reverse and pencil. The results are provided in Table 2.

TABLE 1

| | Brand | PE1 | PE2 | PE3 | PE4 |
|---|---|---|---|---|---|
| | name/type | (g) | (g) | (g) | (g) |
| Component | | | | | |
| Si-Polyester | EM185451 | 273.00 | 273.00 | 227.50 | 273.00 |
| | Reichhold | | | | |
| | Inc. | | | | |
| Melamine | Akzo | 5.25 | 5.25 | 4.55 | 5.25 |
| Hardener | ZP-1238 | | | | |
| Pigment | Kronos | 49.00 | 49.00 | | |
| | 2310 | | | | |
| Pigment | Kronos | | | 91 | 17.50 |
| | Titandioxid | | | | |
| | 2063 | | | | |
| Pigment | Ferro | 1.05 | | | |
| | PK3095 | | | | |
| Pigment | Degussa | | 1.05 | 1.05 | |
| | Flammruβ101 | | | | |
| Pigment | Carbot | | | | 1.05 |
| | Monarch | | | | |
| | 1300 | | | | |
| Degassing | Benzoin | 1.75 | 1.75 | 1.75 | 1.75 |
| Agent | (merck) | | | | |
| Leveling | Worlee | 4.20 | 4.20 | 5.25 | 4.20 |
| Agent | Resiflow | | | | |
| | PV88 | | | | |
| Extrusion | | | | | |
| Heated | | 60 | 60 | 60 | 60 |
| Zone | | | | | |
| Temperature | | | | | |
| ° C. (1) | | | | | |
| Heated | | 110 | 110 | 110 | 110 |
| Zone | | | | | |
| Temperature | | | | | |
| ° C. (2) | | | | | |
| Screw | | 150 | 150 | 110 | 110 |
| Speed (rpm) | | | | | |
| Torque (%) | | 43 | 43 | 44 | 44 |

TABLE 2

| | Hot | | | | | | | | |
|---|---|---|---|---|---|---|---|---|---|
| | Hardness | | | | | | | | |
| | (ASTM | | | | | | | | |
| | D3363 | | | | Cross | | | | |
| | after | | | | Cut | MEK(dr) | | | |
| | coating | | | | Adhesion | (PCI | | | |
| | has been | Film | Gloss | | (1 mm) | Recommended | Impact | Reverse | Pencil |
| | exposed to | Thickness | (ASTM | | (ASTM | Test Procedure | (ASTM | (ASTM | (ASTM |
| | 200° C.) | (μm) | D523) | Visual | D3359) | #8) | D2794) | D2794) | D3363) |
| PE1 | H | 25 | 10 | black | 0-1 | >200 | 60-70 | 60-70 | 6H |
| | | | | points | | | | | |
| PE2 | H | 25-30 | 10 | some | 0-1 | >200 | >80 | 70-80 | 6H |
| | | | | black | | | | | |
| | | | | points | | | | | |
| PE3 | | 29 | 15 | | 1 | >200 | <60 | <40 | 6HH |
| PE4 | H | 31 | 10 | | 0 | >200 | <60 | <60 | 6H |

### Example 5

A SMP resin (Fine-Clad® EM-185457; 81.7%) was extruded with an aminoplast hardner (Powderlink® 1174 manufactured by Cytec Industries, Inc.; 1.6%), a white pigment (Kronos 2310; 14.6%) and a black pigment (Degussa Special Black 6; 0.3%), a degassing agent (Benzoin, manufactured by GCA Chemical Corp.; 0.5%) and a leveling agent (Resiflow PV88, manufactured by Estron Chemical, Inc.; 1.3%). Extrusion parameters: W&P ZSK 30 mm extruder; Zone 1=110° C.; Zone 2=90° C.; Screw Speed=300 rpm. Coating was then cured for 10 minutes at 204° C.

The resulting resin had a hot hardness of 5H pencil hardness and a gloss of less than 10 at 60° C.

### Example 6

A SMP resin (Fine-Clad® EM-185457; 75.0 parts per hundred resin plus catalyst) was extruded with an IPDI hardner (Vestagon B-1530, manufactured by Degussa; 25.0 phr), a high temperature extender (Pyrax 300, manufactured by RT Vanderbilt; 50 phr), a black pigment (Degussa Special Black 6; 1.0 phr); a degassing agent (Benzoin, manufactured by GCA Chemical Corp.; 0.5 phr) and a leveling agent (Resiflow PV88, manufactured by Estron Chemical, Inc.; 1.0 phr). Extrusion parameters: W&P ZSK 30 mm extruder; Zone 1=110° C.; Zone 2=90° C.; Screw Speed=300 rpm. Coating was cured for 10 minutes at 204° C.

The resulting resin has the following properties: Over Bake for 24 minutes at 500° F. gave ΔE color shift <5.0; initial gloss—low to satin (25 at 60° angle); impact (160/160 impact) and initial pencil hardness (2H).

### Example 7

Table 3 describes several resins made with an extrusion process similar to that described with reference to Examples 1, 2 and 3.

TABLE 3

| Polyester Product | | | |
|---|---|---|---|
| Stream | % Si | T_{g} (° C.) | OH value |
| Polyester 1 | 30 | 55 | 60 |
| (IPA, TMP, NPG) | | | |
| Polyester 2 | 45 | 60 | 190 |
| (9/1 IPA/TPA, TME, NPG) | | | |
| Polyester 3 | 60 | 62 | 140 |
| (9/1 IPA/TPA, TME, NPG) | | | |
| Polyester 4 | 45 | 63 | 33 |
| (tPA, NPG, ethylene glycol - | | | |
| EG, glycerine) | | | |

### Example 8

Table 4 describes several resins made with an extrusion process similar to that described with reference to Examples 1, 2 and 3. The mixtures were extruded in a twin-screw extruder with multiple heat zones (Baker-Perkins model MP19PC). The feed rate was ˜3-4 kg/hour (feed rate adjusted to maintain screw torque of 50-55), the screw speed was 250 rpm and only second vent was open.

| Zone (from Feed End) | Temperature (° C.) |
|---|---|
| 1 | 36 |
| 2 | 100 |
| 3 | 120 |
| 4 | 140 |
| 5 | 160 |
| 6 | 165 |
| 7 | 165 |
| 8 | 165 |

TABLE 4

| Polyester Product Stream | % Si | Tₛ | T_{fb} | T_{1/2} | T_{end} |
|---|---|---|---|---|---|
| EM-186109 | 0 | 72.5 | 86.9 | 107.2 | 113.8 |
| (TPA/IPA/EG/ethoxylated | | | | | |
| Bis A/trimellitic anhydride) | | | | | |
| control | | | | | |
| Modification 1 - 95% EM186109 | 5 | 73.9 | 88.1 | 108.4 | 115.2 |
| Modification 2 - 90% EM186109 | 10 | 73.2 | 87.2 | 107.5 | 114.3 |
| Modification 3 - 80% EM186109 | 20 | 72.7 | 86.5 | 105.8 | 112.7 |

What is claimed:

1. A process for making a silicone-modified polyester resin, comprising reactively extruding a dry mixture comprising a solid polyester resin and a solid silicone resin.

2. The process of claim 1, wherein the dry mixture of the solid polyester resin and the solid silicone resin is reactively extruded in screw-feed barrel extruder.

3. The process of claim 1, wherein the maximum temperature of the reactive extrusion is less than about 180° C.

4. The process of claim 1, wherein the maximum temperature of the reactive extrusion is less than about 170° C.

5. The process of claim 2, wherein the dry mixture is reactively extruded for less than about 2 minutes.

6. The process of claim 1, wherein the solid silicone resin has a glass transition temperature of greater than about 50° C.

7. The process of claim 6, wherein the solid silicone resin has a glass transition temperature in a range of about 57° C. to about 64° C.

8. The process of claim 1, wherein the solid polyester resin has a glass transition temperature of greater than about 45° C.

9. The process of claim 8, wherein the solid polyester resin has a glass transition temperature in a range of about 52° C. to about 60° C.

10. The process of claim 1, comprising reactively extruding a dry mixture comprising a solid polyester resin and a solid silicone resin,
wherein the solid silicone resin is present in the dry mixture at a concentration in a range of about 30 weight percent to about 60 weight percent, and wherein the sum of the weight percent of the solid polyester resin and the solid silicone resin equals 100 weight percent.

11. The process of claim 1, comprising reactively extruding a dry mixture comprising a solid polyester resin and a solid silicone resin,
wherein the solid polyester resin is present in the dry mixture at a concentration in a range of about 40 weight percent to about 70 weight percent, and wherein the sum of the weight percent of the solid polyester resin and the solid silicone resin equals 100 weight percent.

12. The process of claim 1, wherein the solid polyester resin comprises a catalyst.

13. The process of claim 12, wherein the catalyst comprises a dibutyltin and/or phosphite-based catalyst.

14. The process of claim 1, wherein the solid silicone resin comprises less than 20 percent difunctional silicone units.

15. The process of claim 1, wherein the solid silicone resin comprises greater than about 80 weight percent tri- and quadra-functional silicon oxide units and less than about 6 weight percent silanol/alkoxy functional silicon oxide units.

16. The process of claim 1, wherein the solid polyester resin has a phenol content of greater than about 30 weight percent.

17. The process of claim 1, wherein the solid polyester resin comprises a hydroxylated polyester having an OH content of greater than about 40 and an acid value of less than about 10.

18. A process for making a silicone-modified polyester resin, comprising reactively extruding a dry mixture comprising a solid polyester resin and a solid silicone resin,
wherein the solid silicone resin is present in the dry mixture at a concentration in a range of about 30 weight percent to about 60 weight percent, and wherein the sum of the weight percent of the solid polyester resin and the solid silicone resin equals 100 weight percent.

19. A process for making a silicone-modified polyester resin, comprising reactively extruding a dry mixture comprising a solid polyester resin and a solid silicone resin,
wherein the solid polyester resin is present in the dry mixture at a concentration in a range of about 40 weight percent to about 70 weight percent, and wherein the sum of the weight percent of the solid polyester resin and the solid silicone resin equals 100 weight percent.
